(19) United States
(12) Patent Application Publication
(10) Pub. No.: US 2008/0085039 A1
(43) Pub. Date: Apr. 10, 2008

(54) Fingerprint matching method and apparatus using fingerprint minutiae and fingerprint binary images

(75) Inventors: Dae Sung Moon, Daejeon-city (KR); Sung Bum Pan, Daejeon-city (KR); Seung-Hoon Chae, Jeollanam-do (KR); Ki Young Moon, Daejeon-city (KR); Kyo Il Chung, Daejeon-city (KR); Sung Won Sohn, Daejeon-city (KR)

Correspondence Address: BLAKELY SOKOLOFF TAYLOR & ZAFMAN, 1279 OAKMEAD PARKWAY, SUNNYVALE, CA, 94085-4040, US

(73) Assignees: Electronics and Telecommunications Research Institute; Industry-Academic Foundation Cooperation

(21) Appl. No.: 11/980,177

(22) Filed: Oct. 30, 2007

(30) Foreign Application Priority Data
Dec. 7, 2005 (KR) 10-2006-0124149

(51) Int. Cl. G06K 9/00

(52) U.S. Cl. 382/125

(57) ABSTRACT

Provided is a fingerprint matching method and apparatus using fingerprint minutiae and fingerprint binary images. The method includes: constructing a template fingerprint database by extracting minutiae information and a binary image of a first fingerprint image; and extracting minutiae information and a binary image of a second fingerprint image to be authenticated and performing authentication by aligning the extracted minutiae information and the binary image of the second fingerprint image with data in the template fingerprint database. Accordingly, the fingerprint matching using the fingerprint binary images is additionally performed, thereby reducing a false acceptance rate (FAR) compared to a conventional minutia-based fingerprint authentication method.

### CROSS-REFERENCE TO RELATED PATENT APPLICATION

This application claims the benefit of Korean Patent Application No. 10-2006-0124149, filed on Dec. 7, 2006, in the Korean Intellectual Property Office, the disclosure of which is incorporated herein in its entirety by reference.

### BACKGROUND OF THE INVENTION

1. Field of the Invention

The present invention relates to a fingerprint matching method and apparatus using fingerprint minutiae and binary images, and more particularly, to a method and apparatus for matching fingerprints using binary images in addition to fingerprint minutiae in order to reduce a false acceptance rate (FAR), which is a problem of a method of authenticating a user by comparing two fingerprints using only fingerprint minutiae. This work was supported by the IT R&D program of MIC/IITA.[2005-S-059-02, Development of Large-Scale Biometric Service System].

2. Description of the Related Art

In general, fingerprint authentication methods are classified into image-based fingerprint authentication methods and minutia-based fingerprint authentication methods.

Ridge information is used in the image-based fingerprint authentication method, which is one of the conventional methods using overall directionality information on fingerprint images by applying techniques such as a Garber filter, a fast Fourier transform (FFT), a gradient, a directionality histogram, projection, and the like.

The minutia-based fingerprint authentication method is a general method wherein minutiae extraction and matching are performed based on spatial features of extracted minutiae by applying various image processing techniques such as smoothing, separating foreground from background, binarization, thinning, and the like.

The fingerprint authentication methods described above are mostly independently operated, so that a recognition performance, such as a false acceptance rate (FAR), is limited.

### SUMMARY OF THE INVENTION

The present invention provides a fingerprint matching method and apparatus capable of performing more precise authentication by performing two fingerprint comparison operations by using fingerprint minutiae and fingerprint binary images.

According to an aspect of the present invention, there is provided a fingerprint matching method using fingerprint minutiae and fingerprint binary images, comprising:

constructing a template fingerprint database by extracting minutiae information and a binary image of a first fingerprint image; and

extracting minutiae information and a binary image of a second fingerprint image to be authenticated and performing authentication by aligning the extracted minutiae information and the binary image of the second fingerprint image with data in the template fingerprint database.

According to another aspect of the present invention, there is provided a fingerprint matching apparatus using fingerprint minutiae and fingerprint binary images, comprising:

an extractor receiving a first template fingerprint image and a second fingerprint image to be authenticated and extracting minutiae information and binary images to be output from the first and the second fingerprint image;

an align parameter searching unit obtaining a difference between the two minutiae based on the minutiae information on the first and the second fingerprint images;

an alignment unit aligning the two minutiae and the binary images based on the difference; and

a matching unit performing authentication by aligning the two aligned minutiae and the binary images.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a general structure of an apparatus for executing a fingerprint matching method according to an embodiment of the present invention;

FIG. 2 is a block diagram showing a structure of a fingerprint matching apparatus according to an embodiment of the present invention; and

FIG. 3 is a flowchart showing operations of a fingerprint matching method according to an embodiment of the present invention.

### DETAILED DESCRIPTION OF THE INVENTION

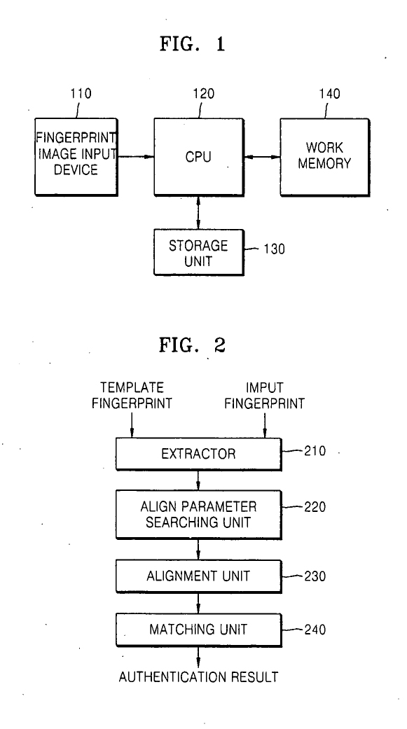

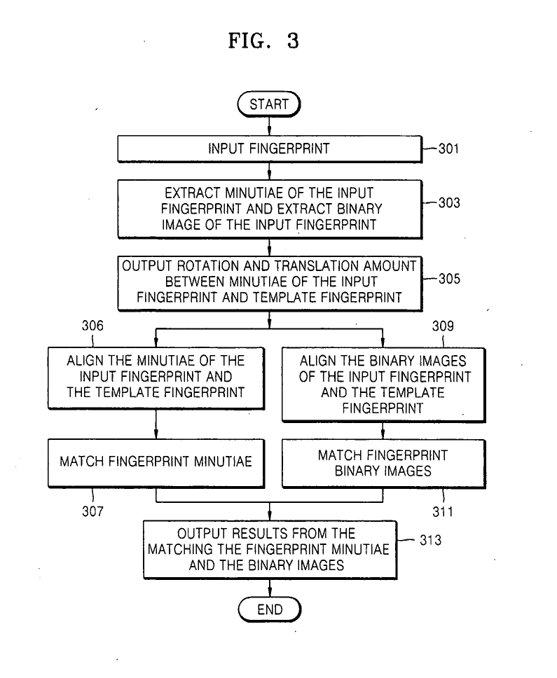

Hereinafter, exemplary embodiments of the present invention will be described in detail with reference to the attached drawings. FIG. 1 is a block diagram showing a general structure of an apparatus for executing a fingerprint matching method according to an embodiment of the present invention. FIG. 2 is a block diagram showing a structure of a fingerprint matching apparatus according to an embodiment of the present invention. FIG. 3 is a flowchart showing operations of the fingerprint matching method according to an embodiment of the present invention. We denote the representation of the fingerprint acquired during enrollment as “template fingerprint” and the representation of the fingerprint to be matched as “input fingerprint”.

Referring to FIG. 1, the apparatus for fingerprint matching includes a fingerprint image input unit 110, a central processing unit (CPU) 120, a storage unit 130, and a work memory 140.

Fingerprint authentication according to the embodiment includes a registration process and an authentication process.

First, in the registration process, when a fingerprint image of a user is input to the fingerprint image input unit 110, minutiae of the fingerprint image are extracted and information on needed minutiae and a fingerprint binary image that is intermediate result of the minutiae extraction are acquired by the CPU 120 and the work memory 140 to be stored in the storage unit 130.

Next, in the authentication process, after a fingerprint of a person to be matched is input to the fingerprint image input unit 110, minutiae information extracted by the same method as that in the registration process and a fingerprint binary image are aligned with the minutiae information of the fingerprint image of the user stored in the storage unit 130 in advance by the CPU 130 and the work memory 140, and the result of the aligning is transmitted.

Now, a more detail description is provided with reference to FIGS. 2 and 3.

First, an extractor 210 receives a first fingerprint image registered through the aforementioned registration process and a second fingerprint image to be authenticated, extracts minutia information and a binary image and outputs to an align parameter searching unit 220 (operations 301 to 303).

The align parameter searching unit 220 obtains a difference between two minutiae based on minutiae information on the first and the second fingerprint images. More specifically, the align parameter searching unit 220 outputs a difference (θ,Δx,Δy) between positions and directions of the two minutiae as a difference of two minutiae and also outputs binary data generated in the minutiae extraction operation as a binary image of the fingerprint (operation 305). Here, a method of obtaining an align parameter used for the difference (θ,Δx,Δy) between the positions and directions and the generated binary data will be understood by those skilled in the art, so that a detailed description will be omitted.

An alignment unit 230 receives the two minutiae and the binary images output from the align parameter searching unit 220, aligns minutiae of the input fingerprint and the template fingerprint(that is, the registered fingerprint) based on the obtained alignment parameter (θ,Δx,Δy) (operation 306), and simultaneously aligns the binary images of the input fingerprint and the template fingerprint (operation 309). The alignment method will be understood by those skilled in the art, so that a detailed description will be omitted.

A matching unit 240 obtains similarity values by aligning the aligned two minutiae with each other and the binary images with each other and performs matching (operations 307 and 311). A combination unit for performing the matching by combining the result of calculating the similarity value of the two minutiae and the result of calculating the similarity valued of the binary images may further be included.

As described above, the fingerprint matching method and apparatus using the fingerprint minutiae and the fingerprint binary images according to the embodiment obtain the align parameters such as a rotation difference and an translation difference by using the minutiae of the two fingerprints when finger matching and obtain a final fingerprint authentication result by using the minutia-based fingerprint matching performance result and the fingerprint binary image-based fingerprint matching performance result. The fingerprint binary image used in the embodiment is output as an intermediate result in the minutia-based fingerprint matching method. According to the embodiment of the present invention, the fingerprint matching using the fingerprint binary images is additionally performed, so that an FAR is reduced as compared with conventional minutia-based fingerprint authentication methods.

In addition, a false fingerprint image generated by using minutia information may cause a problem in conventional minutia-based fingerprint authentication methods; however, according to the present invention, such problem is avoided.

In addition, the present invention may be used in fields where security performance is important and is robust against attacks using a fingerprint generation program.

The fingerprint matching method using fingerprint minutiae and fingerprint binary images according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. In addition, a font ROM data structure can also be embodied as computer readable codes on a computer readable recording medium such as ROM, RAM, CO-ROMs, magnetic tapes, hard disks, floppy disks, flash memories, and optical data recording storage devices.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A fingerprint matching method using fingerprint minutiae and fingerprint binary images, comprising:
constructing a template fingerprint database by extracting minutiae information and a binary image of a first fingerprint image; and
extracting minutiae information and a binary image of a second fingerprint image to be authenticated and performing authentication by aligning the extracted minutiae information and the binary image of the second fingerprint image with data in the template fingerprint database.

2. The fingerprint matching method of claim 1, wherein the extracting minutiae information and a binary image of a second fingerprint image to be authenticated and performing authentication comprises:
obtaining a difference between the two minutiae based on the minutiae information on the first and the second fingerprint images;
aligning the two minutiae and the binary images according to the difference; and
performing the authentication by aligning the aligned two minutiae with each other and the binary images with each other.

3. The fingerprint matching method of claim 2, wherein the difference between the two minutiae is a difference of positions and directions between two minutiae.

4. The fingerprint matching method of claim 1, wherein the binary image is binary data generated in the minutiae extraction operation.

5. The fingerprint matching method of claim 2, wherein the binary image is binary data generated in the minutiae extraction operation.

6. The fingerprint matching method of claim 2, wherein the performing the authentication further comprises performing the authentication by combining a result of calculating a similarity value between the two minutiae and a result of calculating a similarity value between the binary images.

7. A fingerprint matching apparatus using fingerprint minutiae and fingerprint binary images, comprising:
an extractor receiving a first template fingerprint image and a second fingerprint image to be authenticated and extracting minutiae information and binary images to be output from the first and the second fingerprint image;
an align parameter searching unit obtaining a difference between the two minutiae based on the minutiae information on the first and the second fingerprint images;
an alignment unit aligning the two minutiae and the binary images based on the difference; and
a matching unit performing authentication by aligning the two aligned minutiae and the binary images.

8. The fingerprint matching apparatus of claim 7, wherein the align parameter searching unit outputs a difference of positions and directions between the two minutiae as the difference between the two minutiae.

9. The fingerprint matching apparatus of claim 7, wherein the align parameter searching unit outputs binary data generated in the minutiae extraction operation as the fingerprint binary image.

10. The fingerprint matching apparatus of claim 7, further comprising a combination unit performing the authentication by combining a result of calculating a similarity value between the two minutiae and a result of calculating a similarity valued between the binary images.
